(19) United States
(12) Patent Application Publication
(10) Pub. No.: US 2014/0280739 A1
(43) Pub. Date: Sep. 18, 2014

(54) HASHTAG COMMUNICATION METHOD AND SYSTEM

(71) Applicant: Igor Ljubin, Ljubljana (SI)

(72) Inventor: Igor Ljubin, Ljubljana (SI)

(21) Appl. No.: 14/205,428

(22) Filed: Mar. 12, 2014

Related U.S. Application Data
(60) Provisional application No. 61/798,592, filed on Mar. 15, 2013.

(51) Int. Cl. H04L 29/08

(52) U.S. Cl. CPC H04L 67/02
USPC 709/218

(57) ABSTRACT

An Uniform Resource Identifier (URI) fragment based web portal browsing (#wise) represents a functionality that allows internet users to use the universal resource identifiers with “#” (number sign) and either an empty or a non empty fragment to, based on predetermined set of rules, technical and other conditions and the internet user interaction history, quickly and efficiently browse a certain website by being presented with suggested website administrator managed non-user-generated content (such as, but not limited to videos, PDF documents, drawings, etc.), redirections (other URIs) and actions (such as, but not limited to sending an email to a certain email address, initiating audio/video/chat conversation, posting a support ticket etc.) requiring minimal amount of additional user intervention

### CROSS-REFERENCE TO RELATED APPLICATION

This application claims the benefit of U.S. Provisional Application No. 61/798,592, filed Mar. 15, 2013.

### BACKGROUND OF THE INVENTION

A uniform resource identifier (URI) is a compact sequence of characters that identifies an abstract or a physical resource.ⁱ A generic URI syntax consists of a hierarchical sequence of components referred to as scheme, authority, path, query and fragment.ⁱⁱ Please refer to FIG. 1 for an example of a URI and its component parts. ⁱ Uniform Resource Identifier (URI): Generic Syntax, Network Working Group, January 2005, Page 1, Abstractⁱⁱ Uniform Resource Identifier (URI): Generic Syntax, Network Working Group, January 2005, Page 16, Section 3, Syntax Components

As shown in FIG. 1, the fragment component is indicated by the presence of a number sign (“#”) and terminated by the end of the URI. The fragment identifier component of an URI allows indirect identification of a secondary resource by reference to a primary resource and additional identifying information. The identified secondary resource may be some portion or subset of the primary resource, some view on representations of the primary resource, or some other resource defined or described by those representations. ⁱⁱⁱUniform Resource Identifier (URI): Generic Syntax, Network Working Group, January 2005, Page 24, Section 3.5, Fragment http://tools.ietf.org/html/rfc3986#page-24

Some websites (like, for example, twitter.com), use fragment in order to provide additional functionalities (e.g., topic related user-generated content search in their case).

New widely spread internet technologies and standards such as RTMP and webRTC allow internet users to start an audio, a video, a chat or a conversation of a combined (audio-video, audio-chat, video-chat, audio-video-chat) type with a minimal amount of user intervention.

### SUMMARY OF THE INVENTION

This invention relates to an internet usage system (utilizing a personal computer or other internet communication capable device such as, but not limited to a smart phone or a tablet) focusing on reducing website search complexity, specifically, selection of relevant website administrator managed non-user-generated content, redirections and other actions of interest.

The invention includes a system that uses the power of URI fragments to identify resources, however, the invention is much more than that. The invention, a Uniform Resource Identifier (URI) fragment based web portal browsing (#wise), represents a functionality that allows internet users to use the universal resource identifiers with “#” (number sign) and either an empty or a non empty fragment to, based on predetermined set of rules, technical and other conditions (e.g. internet speed, location, time, day of week etc.) and the internet user interaction history, quickly and efficiently browse a certain website by being presented with suggested non-user-generated content (such as, but not limited to videos, PDF documents, drawings, etc.), suggested redirections (other URIs), or suggested actions (such as, but not limited to sending an email to a certain email address, initiating audio/video/chat conversation to a certain phone number, posting a support ticket etc.) requiring minimal amount of user intervention.

The advantages of the invention include but are not limited to a cost-effective system to efficiently utilize a variety of resources through the internet in a user-friendly customized manner. The invention presents a system with multiple functions, as described above and in the description to follow, which can be easily utilized with limited website user and website administrator intervention. Existing leading search engines do not necessarily perform in accordance with websites user interaction policies. Same features that enable modern search engines to analyze vast amounts of data and work it within a monetable business model, limit their performance when applied on a single web site level. URI fragment based website search non-user-generated content reduces search complexity and simplifies website user interaction policy enforcement as never before used on the internet.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates an example URI and its component parts.

FIG. 2 is a high level diagram showing #wise usage protocol of the present invention that ends with a communication initiation with user intervention

FIG. 3 is a detailed diagram that illustrates the process steps behind the #wise usage protocol according to one embodiment of the present invention.

FIG. 4-A represents a business card encouraging internet users to use #wise compliant URLs in order to initiate communication with Example LLC CEO, John Smith according to one embodiment of the present invention.

FIG. 4-B represents a business card encouraging internet users to use #wise compliant URLs in order to initiate communication with Example LLC secretary, Anna Walker according to one embodiment of the present invention.

FIG. 5-A shows website example.com presenting possibilities to an internet user using a “management” fragment according to the present invention. User is presented with a possibility to a. initiate sending an email to Mr. Smith, b. initiate calling or sending an email to Mrs. Walker, c. watch a presentational video or d. be redirected to contacts or mission and vision page.

FIG. 5-B shows a phone call to Mrs. Walker being initiated from the website of the present invention.

### DETAILED DESCRIPTION OF THE INVENTION

A description of example embodiments of the invention follows.

The proposed approach (“#wise”), is a system that merges current internet technologies and standards with the newest sociological trends in order to allow internet users to easily find and select appropriate non-user-generated website content, redirection or other action of interest. Non-user-generated content, redirections and actions are suggested and selected, using a predetermined set of rules, requiring minimal amount of additional user intervention, such as, but not limited to, clicking a mouse, tapping a screen, pressing a key, moving or shaking a device, or reproducing or creating a sound at the internet user side.

In order for a website owner or administrator to be able to provide website users with intelligent suggestions, #wise requires minimal technical expertise and allows dynamic and thus cheaper website management as never before used on the internet.

It is an object of the invention to provide a functionality that enables internet users to use URIs with the “#” (number sign) and either an empty or non-empty fragment (a #wise compliant URI) to, based on a predetermined set of rules, be suggested with appropriate set of suggestions (e.g. start an audio, a video or a chat conversation or a conversation of a combined (audio-video, audio-chat, video-chat, audio-video-chat) type, send an email, post a support request, post a callback request etc.) to an appropriate action target, using a predetermined set of rules, the type requiring minimal amount of user intervention.

Above mentioned usage of the #wise compliant URI includes actions such as, but not limited to, typing it, selecting it or being redirected to one.

FIG. 2 is a high level diagram showing #wise usage protocol that ends with a communication initiation. FIG. 2, step 1 illustrates a user request made through or on (i.e. using) a user device, such as but not limited to, a mobile phone, a smart phone, a computer/laptop, or other digital processing device. A user request may include, but is not limited to, selecting, retyping, or being redirected to a UFBCI compliant URI. FIG. 2, step 2, illustrates the user device communication with one or more internet services, providing the internet services with parts of or a complete URI, and the internet user, device and connection properties. The next step in FIG. 2, step 3, based on the internet services responses, parts of or a complete URI and/or internet, user device and connection properties, and based on a set of rules, the device either presents the user with an action selection interface or initiates the suggested action or redirects to another URI. FIG. 2, step 4, illustrates that the user optionally intervenes in order to decide on one of the possibilities presented. FIG. 2, step 5, illustrates the device presenting the user with the device functionality (e.g. capturing audio or video) usage permission dialogue. Optionally, the selection process can be cancelled at this point due to other reasons (e.g. user inactivity). FIG. 2, step 6, illustrates the device presenting the selected non-user-generated content, redirecting to the selected URI or initiating the selected action (e.g. starting a call) or, if so decided within the step 5, canceling or restarting the selection process starting from FIG. 5, step 2.

FIG. 3 is a detailed diagram that illustrates the process steps behind the #wise usage protocol of the present invention. In the example (FIG. 3), element 300, the first step 301 shows that website owner or administrator first Website administrator configures internet services to adequately serve #wise enabled non-user-generated content, redirections and action suggestions. Then 302 shows that the user first, inputs or is redirected to a URI with an empty or non-empty fragment (e.g. http://www.example.com/#ceo or http://www.example.com/#). Then (303) the Browser requests the resource identified by the URI from the appropriate internet service (in this case an http server serving www.example.com websites default page). In the next step 304, the Browser processes the #wise software located within the requested resource and creates zero or more requests to internet services presenting them with different URI, user, device and connection related information.

If configured so, #wise software waits for the resource loading, browser loads the resource and #wise software creates additional zero or more requests to internet services presenting them with different URI, user, device and connection related information and than checks if the fragment represents an element located within the loaded resource (307) and if yes, stops the execution, otherwise continues.

If the fragment meets a set of rules to be considered for processing in 308 (e.g. the fragment is long enough, or starts with a certain word), then the processing continues, otherwise the process returns. If processing continues, 309, then the #wise software creates several requests to internet services presenting them with different URI, user, device and connection related information. In the next step 310, based on information gathered from the internet services and current device or device type (for example, does it have a microphone and/or camera or not) and user and connection properties (speed), and a set of rules, create a ranked list of potential actions, documents and redirections (list of suggestions). In the next step 311, if the list of suggestions is either too weak or empty the process returns, otherwise the process continues.

Next, optionally an automatic or manual selection method is configured, based upon a set of rules. If the configuration is automatic, the strongest suggestion is presented to the user automatically, 312. If the configuration is manual, then the user is presented with a set of suggestions through a selection interface 313, and the user then selects a suggestion or closes the interface 314. If the user makes a selection, 315, or the automatic selection is configured, then the selected action is processed, 316, (e.g. making a phone call) or a selected document is presented or the user is redirected to the selected location. Next, the user data is recorded, 317 (e.. collecting feedback showing that the suggestion is correct. This data is optionally considered the next time another user selects the same fragment.

It is preferred that the predefined set of rules mentioned above represents website owner's internet user interaction strategy by including information such as, but not limited to, languages of a person or group being targeted by an action (e.g. receiving the conversation) that are prominent in geographic locations and/or business areas the person or group being targeted by an action is covering.

It is preferred that the predefined set of rules mentioned above represents a website owner's internet user interaction strategy by including information such as, but not limited to, name, surname, email, phone number or phone extension number of the person being targeted by an action.

It is preferred that the predefined set of rules mentioned above represents a website owner's internet user interaction strategy by including information such as, but not limited to, group name, group email, group phone number or group phone extension number of the group being targeted by an action.

It is preferred that the predefined set of rules mentioned above includes rules for suggesting non-user-generated content, actions and redirections based on the local date, local time or location of the internet user initiating the conversation and its current technical limitations.

It is preferred that the predefined set of rules mentioned above includes rules for suggesting actions, non-user-generated content and redirections based on working hours, local date, local time or location of the person receiving the conversation its current technical limitations. In one example embodiment of the invention, the invention may have different configurations, such that during business hours a suggested action may be a phone call, however, during late evening hours a suggested action may be an email.

It is preferred that the predefined set of rules mentioned above includes rules for defining different suggestion priorities based on previous behavior of the internet user (e.g. already made phone calls to a certain person), or previous behavior of other internet users using the same fragment (e.g. longer watching of a certain content).

It is preferred that the predefined set of rules mentioned above includes rules for defining fragment matching level criteria (e.g. using “portland” fragment should suggest contacting an real estate agent covering the city of Portland rather than suggesting an agent covering the whole state of Oregon).

It is preferred that the predefined set of rules mentioned above indicates minimal fragment length in order for a fragment to be considered valid for #wise.

It is preferred that the predefined set of rules mentioned above indicates suggestion amount limitation (e.g. not showing no more than three actions per person).

It is not preferred, but is still possible for the predefined set of rules mentioned above indicate an obligatory set of characters at the start of the fragment (e.g. “search:”) for a fragment to be considered valid for fragment #wise.

#wise may also be used with an empty fragment that is using an URI ending with the “#” (number sign).

It is not necessary for the internet user to use a complete URI, that is, using an URI containing all the parts shown in FIG. 1. Some device (user device) used to input, select, redirect to, etc. an URI (e.g. a device with an internet browser) usually automatically fills out the remaining components of the URI, such as adding “http” as scheme, “://” (colon and two leading slashes) between authority and scheme, and setting path to default “/” value.

It is preferred that the predefined set of rules mentioned above indicates a suggestion to be preferably or even exclusively suggested using as a response to using a certain fragment (e.g. communicating with a certain person, or a certain group may be exclusively suggested when using a specific fragment containing full person name, position, extension number, group name etc.).

It is preferred that the predefined set of rules mentioned above indicates a suggestion that is to be automatically selected (without any additional user interaction) using certain fragment (e.g. a conversation to a certain person, or a person belonging to a certain group may be automatically initiated by using a specific fragment containing full person name, position, extension number, group name etc.).

It is not necessary that any of the persons being targeted by certain action are employed by the organization with the domain used in the authority part of the URI. e.g. an organization may provide internet users with a possibility to initiate communication with self employed agents in a steady business relationship with the organization.

#wise may be used for creating a general purpose address book allowing internet users to initiate communication with entities (businesses or private) listed in its address book (e.g. http://call.met#John).

#wise as used by a business, public or other organization allowing internet users to efficiently communicate with both organization employees and organization environment (e.g. resellers, partners etc.) will be described here.

1: Organization with domain example.com may allow internet users to initiate a communication with or post a support ticket to members of a certain department using #wise compliant URIs like http://example.com/#departmentname. In case of the support department http://example.com/#support

2: Organization with domain example.com may allow internet users to initiate a communication with or post a support ticket to its employees or parts of its environment (e.g. partners) covering a certain topic using #wise compliant URIs like http://example.com/#topicidentifier. In case of loans http://example.com/#loans

3: Organization with domain example.com may allow internet users to initiate a communication with or post a support ticket to its employees or parts of its environment covering a certain location using special URIs like http://example.com/#locationidentifier. In case of the State of Oregon http://example.com/#OR

4: Organization with domain example.com may allow internet users to initiate a communication with or post a support ticket to its employees or parts of its environment using #wise compliant URIs containing distinctive pieces of their personal information (e.g. name, surname, position, email, phone number, phone extensions or any distinctive part of them). In case of CEO, John Smith (see business card example shown in FIG. 4-A) with an email john.smith@example.com, phone no. +1 123 45 ext. 678 and could be reachable at http://example.com/#ceo, http://example.com/#john, http://example.com/#smith, http://example.com/#678, http://example.com/#john.smith, http://example.com/#ceo or any other distinctive part of contact information.

5: An organization may also allow internet users to use #wise compliant URIs with non-default (“/”) paths in order to initiate the conversation or post a support ticket. E.g., http://example.com/us/#support could initiate a conversation with or post a support ticket to the organizations support team covering US.

6: An organization may also encourage internet users to use incomplete URI. An example of this would be encouraging internet users in retyping example.com/us#support or example.com#support or example.com/#support, http://example.com#support from a business card or a newspaper add as all of the incomplete URIs listed are usually converted to http://example.com/usNsupport.

7: #wise may be used to allow internet users to initiate communication with or post a support ticket to businesses listed in a business directory (e.g. http://agencies.com/#smithrealestate).

8: In case of using an empty fragment or “info” one of the suggestions could be communicating to group of persons (e.g. two secretaries) that cover most of initial communication with the organization. It is not necessarily strictly predefined which of the two should accept the communication (e.g. one could have higher priority if available or if none of the secretaries is available a third person should receive the communication etc.).

Example LLC owning the domain example.com decides to use #wise to enable internet users to use #wise compatible URIs to initiate phone calls with its CEO John Smith (see FIG. 4-A). Mr. Smith has a GSM phone number that is not to be disclosed to the internet in public, but also has an office phone no. +1 2345 ext. 678. His email is john.smith@example.com and is the only john in the company. Our Example company is a small company and Mr. Smith is also a member of the management board and direct contact person for the potential investors so he has put up a pay-per-click add on LinkedIn targeting investors on international level.

Our first Example LLC CEO, Mr. John smith could be set to be the automatic phone receiver in case of internet users using hnp://example.com/#ceo referring to his position, hnp://example.com/#john.smith referring to his email address, hnp://example.com/#john referring to his name as the distinctive part of his contact information (notice, that Mr. Smith is the only John in Example LLC), http://example.com/#678 referring to his extension number, http://example.com/#invest referring to him being the direct contact person for potential investors.

Writing an email to Mr. Smith is also suggested in case of using http://example.com/#management referring to him being a member of the management board.

Let us also say Mr. Smith has a secretary Mrs. Jane Walker (see business card example shown in FIG. 4-B) with a mobile phone number that is not to be disclosed to the internet public, but also has an office phone no. +1 2345 ext. 001. Her email is anna.walker@example.com and is the only one with the surname Walker in the company. Let us also say that Anna is meant to be the person to handle the most of company communication such handling with new partnering requests, delegating sales and support related calls.

This means that Mrs. Walker would usually be set for the default communication receiver of in case of internet users using hnp://example.com/#info or http://example.com/#.

http://example.com/#jane.walker referring to her email address, http://example.com/#walker referring to her surname as the distinctive part of her contact details, hnp://example.com/#management referring to her being the secretary of Mr. Smith which is the only member of the management board as well as http://example.com/#support referring to her delegating obligations would initiate automatic phone calls to her office desk.

Once Mrs. Walker delegates the support call to one of her support team members the system could (if configured so) next time same internet user uses http://example.com/#support URI suggest the delegated support engineer.

All the potential communication receivers may configure the system so that they have their communication requests terminated depending on the time of the day the conversation requests are being issued.

In our case, Mr. Smith could decide to have all of his direct communication requests being terminated to his email or mobile phone Mon-Fri 8:00 to 9:00 AM because at that time he is usually in the train on his way to the office, than having his direct communication requests terminated to his email or personal desk phone from Mon-Fri 9:00 AM to 16:00 PM. If the internet user is not capable of audio communication he will not be presented with the possibility to start a call with and may post an email instead.

All the communication requests coming out of these hours should be terminated to his email or callback ticketing system.

FIG. 5-A shows a communication initiation interface presented to the internet user typing in example.com#management at Mon-Fri 8:00 AM to 16:00 PM company local time (when both Mr. Smith and Mrs. Walker are reachable at their phones) within a Windows PC with a Chrome Internet browser.

If the user selects the “Free phone call” option in FIG. 5-A, the user is further presented with a prompt shown in FIG. 5-B, and if the user clicks on the “allow” tab the phone call is initiated.

User communication interface may differ depending on the technology used to access specific internet user device modules (e.g. microphone).

The communication initiation interface contains avatars of both Mr. Smith and Mrs. Walker and presents the possibility to initiate a call or send and email to any of them.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method of internet interaction for a user, the method comprising:
a) the user on an internet communication capable device with an internet connection, typing in, selecting, or being redirected to an uniform resource identifier which includes an empty or non-empty fragment (#wise URI), wherein the unified resource identifier identifies a resource within the website and wherein the device can automatically complete the #wise URI using default values and required delimiters,
b) the internet communication capable device communicating with one or more internet services, providing the one or more services with a set of interaction related information, in order to, based on a set of rules, provide the user with a set of suggestions, wherein the set of interaction related information comprises parts of the #wise URI or the whole #wise URI and wherein the set of suggestions comprises non-user-generated content and/or a set of re-directions and/or a set of actions, wherein the non-user-generated content, re-directions and actions are managed by an administrator of the website and wherein the set of suggestions is related to the #wise URI or the web site, and wherein the set of rules comprises information about relevance of a specific suggestion within the set of suggestions to a predefined set of fragments, and wherein an action within the set of actions comprises an action target,
c) a manual or an automatic selection of a suggestion from the set of suggestions wherein the automatic selection comprises the device automatically selecting the suggestion from the set of suggestions without presenting the user with the set of suggestions or the device presenting the user with the set of suggestions, and the device selecting the suggestion from the set of suggestions due to the user inactivity or the device presenting the user with the set of suggestions and the device refusing the presented set of suggestions due to the user inactivity, and wherein the manual selection comprises the device presenting the user with the set of suggestions, and the user selecting the suggestion or the user refusing the presented set of suggestions, wherein the user selecting one of the suggestions or user refusing the presented set of suggestions comprises one or more user-device interactions where a user-device interaction comprises the user pressing a button on the device, the user tapping the screen of the device, the user moving the device, the user creating a sound or the user moving.

2. The method of claim 1, wherein the set of interaction related information comprises at least one of the following:
1. the internet communication capable device property or properties,
2. the internet connection property or properties, or
3. the user property or properties.

3. The method of claim 1 wherein in the step c, the user performs no more than two user-device interactions.

4. The method of claim 1 wherein in the step c, the user performs no more than three user-device interactions.

5. The method of claim 2 wherein in the step c, the user performs no more than two user-device interactions.

6. The method of claim 2 wherein in the step c, the user performs no more than three user-device interactions.

7. The method of claim 1 wherein the set of rules comprises working hours, names, surnames, emails, phone numbers and phone extension numbers, group name, group email, group phone number and group phone extension number, the user interaction history and the interaction history of other users, the user local date, the user local time, location of the user, the action target local date, the action target local time, the action target location.

8. The method of claim 2 wherein the set of rules comprises working hours, names, surnames, emails, phone numbers and phone extension numbers, group name, group email, group phone number and group phone extension number, the user interaction history and the interaction history of other users, the user local date, the user local time, location of the user, the action target local date, the action target local time, the action target location.

9. The method of claim 3 wherein the set of rules comprises working hours, names, surnames, emails, phone numbers and phone extension numbers, group name, group email, group phone number and group phone extension number, the user interaction history and the interaction history of other users, the user local date, the user local time, location of the user, the action target local date, the action target local time, the action target location.

10. The method of claim 4 wherein the set of rules comprises working hours, names, surnames, emails, phone numbers and phone extension numbers, group name, group email, group phone number and group phone extension number, the user interaction history and the interaction history of other users, the user local date, the user local time, location of the user, the action target local date, the action target local time, the action target location.

11. The method of claim 5 wherein the set of rules comprises working hours, names, surnames, emails, phone numbers and phone extension numbers, group name, group email, group phone number and group phone extension number, the user interaction history and the interaction history of other users, the user local date, the user local time, location of the user, the action target local date, the action target local time, the action target location.

12. The method of claim 6 wherein the set of rules comprises working hours, names, surnames, emails, phone numbers and phone extension numbers, group name, group email, group phone number and group phone extension number, the user interaction history and the interaction history of other users, the user local date, the user local time, location of the user, the action target local date, the action target local time or the action target location.

13. A computer system for internet interaction for users, comprising
an internet communication capable device with an internet connection
and a set of internet services implemented on a set of one or more computer servers,
the set of one or more computer servers and the internet communication capable device being operatively configured to:
a. enable a user to type, select, or be redirected to a uniform resource identifier, which includes an empty or non-empty fragment (#wise URI), wherein the unified resource identifier identifies a resource within the website and wherein the device can automatically complete the #wise URI using default values and required delimiters;
b. communicate, through the device, with one or more internet services, providing the one or more services with a set of interaction related information, in order to, based on a set of rules, provide the user with a set of suggestions,
wherein the set of interaction related information comprises parts of the #wise URI or the whole #wise URI and wherein the set of suggestions comprises non-user-generated content and/or a set of re-directions and/or a set of actions, wherein the non-user-generated content, re-directions and actions are managed by an administrator of the website and wherein the set of suggestions is related to the #wise URI or the web site, and wherein the set of rules comprises information about relevance of a specific suggestion within the set of suggestions to a predefined set of fragments, and wherein an action within the set of actions comprises an action target;
c. enable an automatic or manual selection of a suggestion from the set of suggestions wherein the automatic selection comprises the device automatically selecting the suggestion from the set of suggestions without presenting the user with the set of suggestions, or the device presenting the user with the set of suggestions, and the device selecting the suggestion from the set of suggestions due to the user inactivity, or the device presenting the user with the set of suggestions and the device refusing the presented set of suggestions due to the user inactivity, and wherein the manual selection comprises the device presenting the user with the set of suggestions, and the user selecting one of the suggestions or the user refusing the presented set of suggestions, wherein the user selecting one of the suggestions or user refusing the presented set of suggestions comprises one or more user-device interactions wherein a user-device interaction comprises the user pressing a button on the device, the user tapping the screen of the device, the user moving the device, the user creating a sound or the user moving.
